(19) United States
(12) Patent Application Publication
(10) Pub. No.: US 2003/0095018 A1
(43) Pub. Date: May 22, 2003

(54) Microwave filter with reduced penetration of tuning screws

(76) Inventor: Stephen Holme, San Ramon, CA (US)

Correspondence Address: Joyce Kosinski, Loral Space & Communications, Ltd., 655 Deep Valley Drive, Suite 303, Rolling Hills Estates, CA, 90274, US

(21) Appl. No.: 09/990,958

(22) Filed: Nov. 16, 2001

(51) Int. Cl. H01P 1/207

(52) U.S. Cl. 333/209; 333/231

(57) ABSTRACT

Apparatus and method for filtering an electromagnetic signal employs the feeding of the signal via a rectangular waveguide to a plural mode cavity filter with coupling available at plural modes. The cavity has a mode-coupling structure such as a mode-coupling screw. The waveguide operates at a first mode of lower cutoff frequency and a second mode of higher cutoff frequency. The feeding is at a frequency for propagation in the first mode. The cavity radiates back into the waveguide, or into another waveguide, below the higher cutoff frequency to provide an evanescent reactive loading which reduces the required penetration of tuning screws for reduced dissipation of power in the tuning screws.

### BACKGROUND OF THE INVENTION

This invention relates to a filter for an electromagnetic signal and, more particularly, to a construction of a microwave filter with reduced penetration of tuning screws for a corresponding reduction in heat dissipated within the tuning screws.

Microwave filters are used widely in communication systems, as well as in other applications. A form of microwave filter, of considerable interest herein, is constructed of a right cylindrical outer electrically-conductive wall terminated by opposed electrically-conductive end walls that define a cylindrical cavity, the cavity having tuning screws extending inwardly through the cylindrical wall. Slots in the end walls are used for coupling electromagnetic signals to and from the filter for connection with a further filter stage or to an external waveguide.

In the use of such filters for the transmission of electromagnetic signals at high power, such as in a transmitter for a satellite-based communication system, a situation arises in which the tuning screws become heated due to the dissipation of electromagnetic power within the tuning screws. In cases of very high electric field strength, arcing may be observed between a screw and the filter wall. Such arcing becomes more pronounced with increased heating of the tuning screws. Also, the energy dissipated in the heating of the screws would be more beneficially employed for the transmission of the electromagnetic signal. Therefore, the dissipation of heat within the tuning screws presents a disadvantage in the operation of the filter.

### SUMMARY OF THE INVENTION

The aforementioned disadvantage is overcome and other benefits are provided by a construction of the microwave filter, and a procedure for use of the filter in a manner, in accordance with the invention, in which there is a reduction in the length of penetration of each of the tuning screws in the cylindrical wall of a cavity of the filter. This provides for the dual benefits of inhibition of arcing and the reduction of heat dissipation within a tuning screw of the filter cavity.

In a preferred embodiment of the invention, reduction in the length of penetration of a tuning screw into the cavity is accomplished by employing a further tuning element, in addition to the tuning screws, namely, a section of waveguide operated in a mode below the transmission cutoff frequency wherein coupling of electromagnetic signals from the filter cavity into the waveguide is by an evanescent mode. In the evanescent mode, no power is propagated in the waveguide, but a reactive loading is produced upon the filter cavity, which loading aids in the tuning of the filter. In the case of a filter having a cylindrical cavity, coupling of electromagnetic power between the cavity and the waveguide is accomplished by an iris in an end wall of the cavity. In a dual mode filter cavity, there are two tuning screws and a mode coupling screw. The waveguide loads the filter reactively to effect the tuning of the filter in conjunction with the tuning operations of the tuning screws. In the resulting filter, the reactive loading enables the tuning operation of both tuning screws of a dual-mode cavity to be accomplished with a reduction in the length of penetration of the tuning screws into the cavity. This reduces heat dissipation in both of the tuning screws. In the case of a filter cavity with two waveguides coupled to opposite end walls of the cavity, both of the waveguides may provide the reactive loading.

In the preferred embodiment, the filter is a dual mode filter. The cavity is provided with first and second tuning screws positioned perpendicularly in a transverse plane of the cavity for tuning, respectively, first and second modes of the dual modes of electromagnetic waves within the cavity. A third screw is positioned at 45 degrees relative to the first two screws for a coupling of electromagnetic power between the two modes. A cross-shaped iris is employed for coupling electromagnetic power through the end wall between the cavity and the waveguide. One leg of the cross is aligned with the first screw and the second leg of the cross is aligned with the second screw for coupling the respective modes of electromagnetic waves between the cavity and the waveguide.

The waveguide has a rectangular cross section composed of two opposed broad walls and two opposed narrow walls. The widths of each broad wall is greater than the width of each narrow wall to provide different transmission cutoff frequencies for a first mode in which the transverse electric field component is parallel to the narrow walls and a second mode in which the transverse electric field component is parallel to the broad walls. For example, in the case of a waveguide having a ratio of 2×1 in the widths of broad wall relative to narrow wall, the first of the foregoing modes has a cutoff frequency essentially one-half that of the second mode. A signal at the first waveguide mode is inputted to the filter cavity at a frequency greater than the cutoff frequency of the first waveguide mode, but less than the cutoff frequency of the second waveguide mode. The mode-coupling screw enables generations of the second mode within the filter cavity, which second mode is coupled by the iris into the waveguide. However, the second-mode frequency is below the second-mode cutoff frequency, and propagates in the waveguide only in an evanescent mode to produce a reactive loading upon the cavity. Thus, electromagnetic power travels within the waveguide in only the first mode, while the second mode aids in the tuning of the cavity of the filter. As a result, the tuning screws are set for a reduced depth of penetration into the cavity. The tuning can be facilitated further, in accordance with a further feature of the invention, by the provision of additional screws diametrically opposite the foregoing three screws.

### BRIEF DESCRIPTION OF THE DRAWING

The aforementioned aspects and other features of the invention are explained in the following description, taken in connection with the accompanying drawing figures wherein:

FIG. 1 shows a side view of a cavity filter with attached waveguide assembly, constructed in accordance with the invention, with connection to a communication system indicated diagrammatically;

FIG. 2 shows a view of the cavity filter with attached waveguide assembly taken along the line 2-2 in FIG. 1;

FIG. 3 is an exploded view of the cavity filter with attached waveguide assembly;

FIG. 4 is a graph of frequencies for explaining operation of a waveguide of FIG. 1;

FIG. 5 shows a cavity filter of an assembly of plural cavities for use in the practice of the invention;

FIG. 6 shows diagrammatically a construction of cavity filter with plural tuning and mode-coupling screws in conjunction with corresponding balancing screws;

FIG. 7 shows an elongated cavity with an array of tuning and balancing screws;

FIG. 8 shows an alternative arrangement of waveguide assembly connected to the cavity filter for practice of the invention; and

FIG. 9 is a flow chart of steps in the practice of the invention.

Identically labeled elements appearing in different ones of the figures refer to the same element but may not be referenced in the description for all figures.

### DETAILED DESCRIPTION OF THE INVENTION

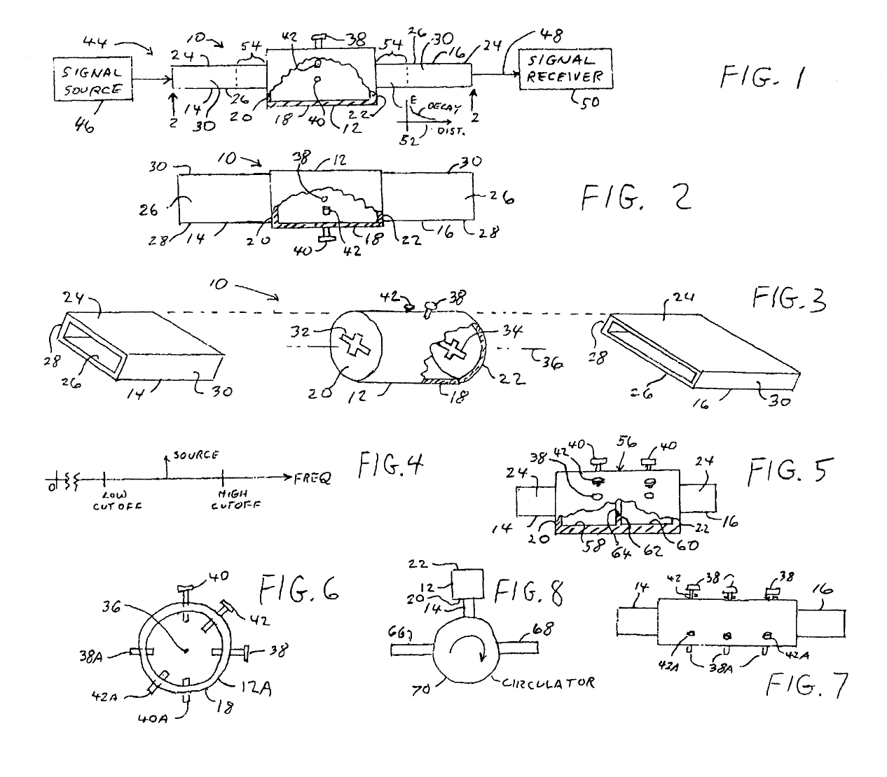

FIGS. 1-3 show a microwave filter 10 constructed in accordance with the invention, and comprising a cavity 12 electromagnetically coupled to a first waveguide 14 and to a second waveguide 16. The cavity 12 is defined by an outer cylindrical wall 18 terminated by end walls 20 and 22, each of the walls 18, 20 and 22 being fabricated of an electrically conductive material such as aluminum or copper. The waveguides 14 and 16 are also constructed of an electrically conductive material such as aluminum or copper. Each of the waveguides 14 and 16 includes two broad walls 24 and 26 interconnected by two narrow walls 28 and 30. Irises 32 and 34 are located in the centers respectively of each of the end walls 20 and 22 of the cavity 12. The waveguides 14 and 16 are joined respectively to the end walls 20 and 22 of the cavity 12, and are arranged coaxially with an axis 36 of the cavity 12 for alignment with the respective irises 32, 34. The irises 32 and 34 serve for coupling, inductively, electromagnetic signals between the cavity 12 and the waveguides 14 and 16 respectively.

Each of the waveguides 14 and 16 has, in cross section, a rectangular configuration wherein the width of a broad wall is greater, typically by a factor of 2, than the width of a narrow wall. Each iris 32, 34 has the configuration of a crossed slot with one of the arms being parallel to the narrow walls of the waveguides 14, 16, and the other of the arms being parallel to the broad walls of the waveguides 14, 16. The cavity 12 is a dual-mode cavity with two tuning screws 38 and 40 aligned with respective ones of the arms of each of the irises 32, 34 for tuning respective orthogonal modes of electromagnetic waves within the cavity 12. The tuning screws 38 and 40 are located in the cylindrical wall 18 in a plane transverse to the cylindrical axis 36, and project inwardly by amounts which are adjustable for tuning the respective modes. Also provided in the cavity 12 is a mode-coupling screw 42 for coupling electromagnetic energy between the two orthogonal modes. A diameter of the cavity 12 is greater than or equal to a diagonal of either one of the waveguides 14 and 16. The arm of the coupling iris 32, 34 which is perpendicular to the wide dimension of either one of the waveguides couples to the waveguide mode below cutoff, the evanescent mode, while the arm on the coupling iris 32, 34 which is parallel to the wide dimension of either one of the waveguides couples to a propagating mode within the waveguide.

The filter 10 may be employed in a communication system 44, as depicted in FIG. 1, wherein a signal source 46 establishes an electromagnetic signal in a transverse electric mode TE₁₀ within the first waveguide 14. The electromagnetic signal is filtered in the cavity 12, and is then outputted by the cavity 12 to the second waveguide 16 in the TE₁₀ mode. The electromagnetic signal then travels from the second waveguide 16 by a communication channel 48 to a receiver 50.

With reference also to FIG. 4, the frequency axis shows the low transmission frequency cutoff value for a transverse electric wave TE₁₀ with electric field parallel to the narrow wall of a waveguide 14, 16, and the high transmission frequency cutoff value for a transverse electric wave TE₀₁ with electric field parallel to the broad wall of a waveguide 14, 16. The frequency of the signal of the source 46 has a value between the values of the two cutoff frequencies, namely, above the low-frequency cutoff but below the high frequency cutoff. Therefore, electric power at the source frequency can propagate as a TE₁₀ mode but not as a TE₀₁ mode. The TE₀₁ mode can exist only as an evanescent mode.

In operation of the filter 10, the signal from the first waveguide 14 is coupled by the iris 32 into the cavity 12 to produce a first mode of vibration of electromagnetic wave within the cavity 12. By operation of the mode coupling screw 42, a second and orthogonal mode of vibration of electromagnetic wave is also established within the cavity 12. The mode-coupling screw 42 serves to couple energy between the two modes so that filtering is accomplished at both of the modes to provide for a filter spectral response having twice the number of poles as for a cavity operating at only a single mode. A filtered wave is outputted by the iris 34 into the second waveguide 16 for communication as a filtered signal to the receiver 50.

By virtue of the crossed slot configuration of each of the irises 32 and 34, electromagnetic energy is radiated into the waveguides 14 and 16 from the electromagnetic wave at the second mode in the cavity 12. The second mode radiation of the cavity 12 induces the TE₀₁ evanescent mode in the waveguides 14 and 16. The evanescent mode does not withdraw power from the cavity 12 but simply presents a reactive load to the tuning operation of the cavity 12. The result of the reactive loading is that both of the mode tuning screws 38 and 40 are effective to tune their respective modes with reduced amounts of penetration of the tuning screws into the cavity 12. Therefore, there is less power dissipated in a tuning screw from interaction of the electric field of a respective one of the waveguide modes with the tuning screw. The electric field, E, of the evanescent mode decays rapidly with increasing distance from the cavity and walls 20 and 22, as shown in the graph 52 appended to the waveguide 16 in FIG. 1. The section of each of the waveguides 14 and 16 in which the significant decay of the electric field occurs is shown at 54 for each of the waveguides. Therefore, the cavity 12 in conjunction with the waveguide sections 54 and the crossed-slot irises 32 and 34 constitute the filter 10 which provides for the reduced dissipation of electromagnetic energy in the tuning screws.

FIG. 5 shows a filter cavity assembly 56 composed of a plurality of cavities, two cavities 58 and 60 being shown by way of example. The cavities 58 and 60 are separated by an iris plate 62 having a crossed-slot iris 64. The iris plate 62 serves as a divider wall between the two cavities 58 and 60, and the iris 64 provides for coupling of electromagnetic energy at both of the orthogonal modes between the two cavities 58 and 60. The cavity assembly 56 terminates in the same end walls 20 and 22 as has been described above cavity 12 (FIG. 1) and may be substituted for the cavity 12 in an alternative embodiment for the construction of the filter 10. Each of the two cavities 58 and 60 is provided with its own set of tuning and mode-coupling screws 38, 40 and 42.

FIG. 6 shows a cavity 12A which is a further embodiment of the cavity 12 wherein additional tuning screws 38A and 40A (balancing screws) are positioned diametrically opposite the tuning screws 38 and 40 to facilitate turning and also, if desired, an additional mode-coupling screw 42A (balancing screw) is positioned opposite the mode-coupling screw 42 to facilitate coupling of power between waves at the two orthogonal modes. In the case of the use of a longer cavity, supporting a higher order mode in a direction along a cylindrical axis of the cavity, namely for TE₁₁ₓ modes in the cavity, a series of the balancing screws 38A can be placed along the length of the cavity opposite the tuning screws 38, in a longitudinal axial plane, as is depicted diagrammatically for a cavity 12B in FIG. 7. Similarly, a series of the balancing screws 42A can be placed along the length of the cavity opposite the mode-coupling screws 42, in a longitudinal axial plane, as is depicted in FIG. 7. The balancing screws facilitate tuning and enhance a balancing between the two modes.

FIG. 8 shows a further connection of the cavity 12 between an input waveguide 66 and an output waveguide 68 by means of a circulator 70. The circulator 70 has three ports, a first of which connects with the input waveguide 66, a second of which connects via the waveguide 14 to the cavity 12, and the third of which connects with the output waveguide 68. In the arrangement of FIG. 8, the cavity end wall 20 is provided with the iris 32 (not shown in FIG. 8, but shown in FIG. 3) while the end wall 22 is provided without its iris. Thus, an input signal in the waveguide 66, as may be provided by the source 46 (FIG. 1), is coupled by the circulator 70 into the waveguide 14 and the filter 12 and, after filtering by the filter 12 which reflects the filtered signal back into the circulator 70, is coupled further by the circulator 70 into the output waveguide 68 for transmission, by way of example, to the receiver 50 (FIG. 1).

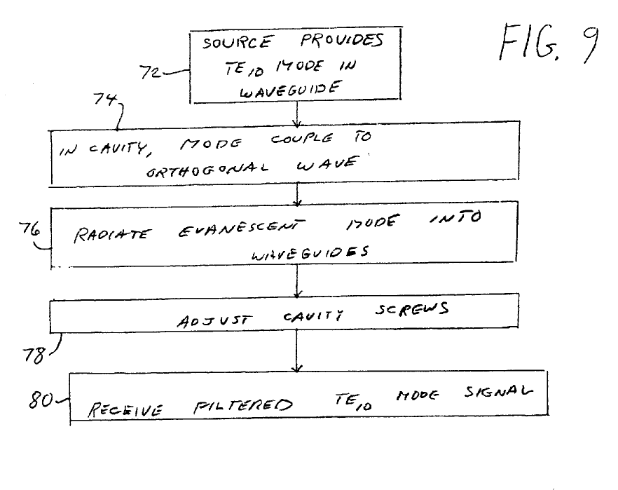

FIG. 9 is a flowchart showing steps in the procedure for carrying forth the operation of the filter 10 in the communication system 44 of FIG. 1. In FIG. 9, the procedure begins at block 72 wherein the signal source 46 excites the transverse electric mode in the first waveguide 14. Then, at block 74, after reception of the microwave energy from the transverse electric wave by the cavity 12, there is a coupling of energy from a first of the two orthogonal wave modes to the second of the two orthogonal wave modes by use of the mode-coupling screw 42. There follows, at block 76, a generation of the evanescent modes in the waveguides 14 and 16 by a coupling of radiant energy from the cavity 12 via the irises 32 and 34 into the waveguides 14 and 16. At block 78, the tuning screws 38 and 40 are adjusted in the presence of the reactive loading produced by the evanescent modes. Thereupon, at block 80, the filtered signal is outputted to the receiver 50 via the transverse electric wave in the waveguide 16.

By way of alternative embodiments, it is noted that the invention can be practiced by connection of the cavity (FIG. 1) or assembly of cavities (FIG. 5) to various arrangements of the waveguides. For example, it is possible to radiate the evanescent mode into only the second waveguide 16 by use of the crossed-slot configuration of coupling aperture in the second end wall 22 while employing only a linear single mode slot (not shown) in the first end wall 20, in which case the first waveguide 14 could have a square cross section. The second waveguide 16 would still function as disclosed in FIG. 1 for extracting the filtered signal from the cavity 12 and for providing the reactive loading of the evanescent mode. Alternatively, such an arrangement of waveguides could be employed, by way of example, with the cavity 12 in conjunction with the circulator of FIG. 8 in which the second waveguide (not shown in FIG. 8) could be connected to the second end wall, as shown in FIG. 1, to serve the sole function of providing the reactive loading of the evanescent mode to the cavity 12, while the first waveguide 14 is used for applying the input signal to the cavity and for extracting the output filtered signal from the cavity. In a more general sense, the invention requires only that there be at least one waveguide connected to at least one cavity of the cavity assembly to produce the reactive loading of the evanescent mode.

It is to be understood that the above-described embodiments of the invention are illustrative only, and that modifications thereof may occur to those skilled in the art. Accordingly, this invention is not to be regarded as limited to the embodiments disclosed herein, but is to be limited only as defined by the appended claims.

What is claimed is:

1. A method of filtering an electromagnetic signal by use of a cavity filter having at least one cavity and a waveguide assembly having at least one waveguide, comprising the steps of:
feeding the signal into said one cavity via said one waveguide, said one waveguide having plural cutoff transmission frequencies respectively for each of plural modes of electromagnetic wave transmission, a first of the waveguide transmission modes having a lower cutoff frequency and a second of the waveguide transmission modes having a higher cutoff frequency, said feeding being accomplished at said first waveguide mode, the cavity filter having tuning screws respectively for each of a plurality of cavity electromagnetic wave modes and a mode-coupling screw for coupling electromagnetic power between the cavity modes;
selecting a frequency of the signal to have a value between the value of a lower one of the cutoff frequencies and the value of a higher one of the cutoff frequencies, the feeding step resulting in the exciting of a first of the cavity modes;
radiating from the cavity electromagnetic power at a second of the cavity modes into said one waveguide of said waveguide assembly, said radiating being accomplished at said second waveguide mode to produce an evanescent reactive loading to said cavity filter; and
adjusting penetration of said tuning screws into a cavity of said cavity filter to tune said filter to said signal frequency, said evanescent loading reducing an amount of penetration of the tuning screws.

2. A method according to claim 1 wherein said radiating step is accomplished by use of an iris plate having an iris configured for exciting said second waveguide mode.

3. A method according to claim 1 comprising steps of connecting a second waveguide of said assembly to said cavity filter and wherein, in said radiating step, there is a radiating from the cavity of electromagnetic power at the second of the cavity modes into both said one waveguide and said second waveguide of said assembly.

4. A method of filtering an electromagnetic signal by use of a cavity filter having at least one cavity and a waveguide assembly having plural waveguides connected to said cavity filter, the cavity filter having tuning screws respectively for each of a plurality of cavity electromagnetic wave modes and a mode-coupling screw for coupling electromagnetic power between the cavity modes, the method comprising the steps of:
feeding the signal into said one cavity via a first waveguide of said assembly;
outputting a filtered signal from said cavity filter via a second waveguide of said assembly, at least one of said first and said second waveguides having plural cutoff transmission frequencies respectively for each of plural modes of electromagnetic wave transmission, a first of the waveguide transmission modes having a lower cutoff frequency and a second of the waveguide transmission modes having a higher cutoff frequency, said feeding being accomplished at said first waveguide mode;
selecting a frequency of the signal to have a value between the value of a lower one of the cutoff frequencies and the value of a higher one of the cutoff frequencies, the feeding step resulting in the exciting of a first of the cavity modes;
radiating from the cavity electromagnetic power at a second of the cavity modes into at least one of said first and said second waveguides of said waveguide assembly, said radiating being accomplished at said second waveguide mode to produce an evanescent reactive loading to said cavity filter; and
adjusting penetration of said tuning screws into a cavity of said cavity filter to tune said filter to said signal frequency, said evanescent loading reducing an amount of penetration of the tuning screws.

5. A cavity filter comprising:
a cavity having tuning screws respectively for each of a plurality of cavity electromagnetic wave modes and a mode-coupling screw for coupling electromagnetic power between a first and a second of the cavity modes, the cavity having a coupling element for coupling electromagnetic energy into the cavity for the first cavity mode;
a waveguide connected to the cavity for feeding electromagnetic energy via the coupling element into the cavity to excite an electromagnetic wave at the first mode, said waveguide having plural cutoff transmission frequencies respectively for each of plural waveguide modes of electromagnetic wave transmission, a first of the waveguide transmission modes having a lower cutoff frequency and a second of the waveguide transmission modes having a higher cutoff frequency, said feeding being accomplished at said first waveguide mode at a signal frequency between the lower one of the cutoff frequencies and the higher one of the cutoff frequencies, the feeding resulting in the exciting of said first cavity mode;
wherein said coupling element also couples energy from a wave in said second cavity mode to excite in said waveguide said second waveguide mode at said signal frequency resulting in an evanescent mode, said evanescent mode reactively loading said cavity for reducing an amount of penetration of the tuning screws into the cavity for reduced dissipation of power in the tuning screws.

6. A cavity filter according to claim 5 wherein said coupling element has a first portion for coupling electromagnetic energy between said first waveguide mode and said first cavity mode, and a second portion for coupling electromagnetic energy between said second waveguide mode and said second cavity mode.

7. A cavity filter according to claim 6 wherein said coupling element is a crossed-slot having a first arm and a second arm crossing the first arm, and said first portion of said coupling element is said first arm, and said second portion of said coupling element is said second arm.

8. A cavity filter according to claim 5 wherein said cavity is a right cylindrical cavity having a cylindrical wall terminated by a first end wall and a second end wall, said coupling element being in said first end wall and said tuning screws being in said cylindrical wall, the filter further comprising a balancing screw for said mode-coupling screw located in said cylindrical wall opposite a location of said mode-coupling screw.

9. A cavity filter according to claim 8 wherein the cavity supports a higher order mode in a direction along a cylindrical axis of the cavity, there being a plurality of said mode-coupling screws located in a series along said cylindrical wall and a plurality of said balancing screws located in a series along said cylindrical wall opposite said series of said mode-coupling screws.

10. A cavity filter according to claim 5 wherein said cavity is a right cylindrical cavity having a cylindrical wall terminated by a first end wall and a second end wall, said coupling element being in said first end wall and said tuning screws being in said cylindrical wall, the filter further comprising a balancing screw for each of said tuning screws located in said cylindrical wall opposite a location of a corresponding one of said tuning screws.

11. A cavity filter according to claim 10 wherein the cavity supports a higher order mode in a direction along a cylindrical axis of the cavity, there being a plurality of said tuning screws for said first cavity mode located in a series along said cylindrical wall and a plurality of said balancing screws located in a series along said cylindrical wall opposite said series of said tuning screws.

12. A cavity filter comprising:
a cavity having tuning screws respectively for each of a plurality of cavity electromagnetic wave modes and a mode-coupling screw for coupling electromagnetic power between a first and a second of the cavity modes, the cavity having a first coupling element and a second coupling element capable of coupling electromagnetic energy into the cavity for the first cavity mode;
a first waveguide and a second waveguide connected to the cavity, respectively, via said first coupling element and said second coupling element to excite an electromagnetic wave at the first cavity mode, each of said waveguides having plural cutoff transmission frequencies respectively for each of plural waveguide modes of electromagnetic wave transmission, a first of the waveguide transmission modes having a lower cutoff frequency and a second of the waveguide transmission modes having a higher cutoff frequency, a feeding of electromagnetic energy to the cavity by one of said waveguides being accomplished at said first waveguide mode at a signal frequency between the lower one of the cutoff frequencies and the higher one of the cutoff frequencies, the feeding resulting in the exciting of said first cavity mode;
wherein at least one of said coupling elements also couples energy from a wave in said second cavity mode to excite in a corresponding one of said waveguides said second waveguide mode at said signal frequency resulting in an evanescent mode, said evanescent mode reactively loading said cavity for reducing an amount of penetration of the tuning screws into the cavity for reduced dissipation of power in the tuning screws.

13. A cavity filter according to claim 12 wherein each of said coupling elements has a first portion for coupling electromagnetic energy between said first waveguide mode and said first cavity mode, and a second portion for coupling electromagnetic energy between said second waveguide mode and said second cavity mode.

14. A cavity filter according to claim 13 wherein each of said coupling elements is a crossed-slot having a first arm and a second arm crossing the first arm, and said first portion of said coupling element is said first arm, and said second portion of said coupling element is said second arm.

15. A cavity filter according to claim 12 wherein said cavity is a right cylindrical cavity having a cylindrical wall terminated by a first end wall and a second end wall, said first coupling element being in said first end wall, said second coupling element being in said second end wall, and said tuning screws being in said cylindrical wall, the filter further comprising a balancing screw for said mode-coupling screw located in said cylindrical wall opposite a location of said mode-coupling screw.

16. A cavity filter according to claim 15 wherein the cavity supports a higher order mode in a direction along a cylindrical axis of the cavity, there being a plurality of said mode-coupling screws located in a series along said cylindrical wall and a plurality of said balancing screws located in a series along said cylindrical wall opposite said series of said mode-coupling screws.

17. A cavity filter according to claim 12 wherein said cavity is a right cylindrical cavity having a cylindrical wall terminated by a first end wall and a second end wall, said first coupling element being in said first end wall, said second coupling element being in said second end wall, and said tuning screws being in said cylindrical wall, the filter further comprising a balancing screw for each of said tuning screws located in said cylindrical wall opposite a location of a corresponding one of said tuning screws.

18. A cavity filter according to claim 17 wherein the cavity supports a higher order mode in a direction along a cylindrical axis of the cavity, there being a plurality of said tuning screws for said first cavity mode located in a series along said cylindrical wall and a plurality of said balancing screws located in a series along said cylindrical wall opposite said series of said tuning screws.

19. A cavity filter comprising:
an assembly of serially connected cavities each of which has tuning screws respectively for each of a plurality of cavity electromagnetic wave modes and a mode-coupling screw for coupling electromagnetic power between a first and a second of the cavity modes, a first cavity of the assembly having a first coupling element and a last cavity of the assembly having a second coupling element capable of coupling electromagnetic energy into the assembly of cavities for the first cavity mode;
a first waveguide and a second waveguide connected to the assembly of cavities, respectively, via said first coupling element and said second coupling element, each of said waveguides having plural cutoff transmission frequencies respectively for each of plural waveguide modes of electromagnetic wave transmission, a first of the waveguide transmission modes having a lower cutoff frequency and a second of the waveguide transmission modes having a higher cutoff frequency, a feeding of electromagnetic energy to the assembly of cavities by one of said waveguides being accomplished at said first waveguide mode at a signal frequency between the lower one of the cutoff frequencies and the higher one of the cutoff frequencies, the feeding resulting in the exciting of said first cavity mode;
wherein at least one of said coupling elements also couples energy from a wave in said second cavity mode to excite in a corresponding one of said waveguides said second waveguide mode at said signal frequency resulting in an evanescent mode, said evanescent mode reactively loading said the assembly of cavities for reducing an amount of penetration of the tuning screws into individual ones of the cavities for reduced dissipation of power in the tuning screws.
